(19) United States
(12) Patent Application Publication
(10) Pub. No.: US 2025/0010247 A1
(43) Pub. Date: Jan. 9, 2025

(54) POROUS SUBSTRATES CONTAINING AMINE-MODIFIED CARBON NANOTUBES

(71) Applicants: SAUDI ARABIAN OIL COMPANY, Dhahran (SA); KING FAHD UNIVERSITY OF PETROLEUM & MINERALS, Dhahran (SA)

(72) Inventors: Fahd I. ALGHUNAIMI, Dhahran (SA); Norah W. ALJURYYED, Dhahran (SA); Hind S. ALDOSSARY, Dhahran (SA); Tawfik A. SALEH, Dhahran (SA)

(73) Assignees: SAUDI ARABIAN OIL COMPANY, Dhahran (SA); KING FAHD UNIVERSITY OF PETROLEUM & MINERALS, Dhahran (SA)

(21) Appl. No.: 18/348,611

(22) Filed: Jul. 7, 2023

(51) Int. Cl. B01D 71/02; B01D 69/12; B01D 71/60; B01D 71/68; C02F 1/00; C02F 1/26

(52) U.S. Cl. CPC B01D 71/0212; B01D 69/12; B01D 71/601; B01D 71/68; C02F 1/004; C02F 1/265; C02F 2101/32

(57) ABSTRACT

Membrane materials may be used for treatment of aqueous fluid. Membrane materials suitable for water treatment may comprise: a base substrate having a plurality of pores defined therein; and a plurality of carbon nanotubes disposed upon the base substrate; wherein the plurality of carbon nanotubes includes oxidized carbon nanotubes having a plurality of carboxylic acid groups; wherein at least a portion of the carboxylic acid groups have been reacted with a polyamine compound via a first amine group of the polyamine compound to form a plurality of amide-linked polyamines bound to at least a portion of the plurality of carbon nanotubes, and at least a second amine group of polyamine compound is further functionalized as a reaction product of an active acyl compound.

### FIELD OF THE DISCLOSURE

The present disclosure relates generally to membrane separations and, more particularly, to membrane separations facilitated by carbon nanotubes.

### BACKGROUND OF THE DISCLOSURE

Membranes are used in a variety of applications, including water treatment (e.g., purification and/or desalination), and may afford benefits including reasonably low operating costs, minimal energy usage requirements, high efficiency, and minimal input of additional chemicals. Semi-permeable membranes are generally preferred for water purification, such as during reverse osmosis treatments. Semi-permeable membranes function by rejecting all or a portion of undesired contaminants within a water source and allowing passage of the water therethrough to achieve an improved state of purity.

Impure water and aqueous fluid sources are encountered in a number of industries, including the oilfield industry. Water and aqueous fluids encountered in the oilfield industry may be contaminated by hydrocarbons (e.g., oil, petroleum, and the like) and/or salts (e.g., inorganic salts), and removal of these impurities from water and aqueous fluids may conventionally require significant energy and capital expenditures, especially in view of the large fluid volumes typically encountered in the oilfield. In many instances, at least partial removal of one or more impurities from water or an aqueous fluid may be needed to render the water or aqueous fluid suitable for further use or to achieve a suitable contaminant level for a specified disposal technique.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

A first nonlimiting embodiment of the present disclosure includes membrane materials, comprising: a base substrate having a plurality of pores defined therein; and a plurality of carbon nanotubes disposed upon the base substrate; wherein the plurality of carbon nanotubes comprises oxidized carbon nanotubes having a plurality of carboxylic acid groups; wherein at least a portion of the carboxylic acid groups have been reacted with a polyamine compound via a first amine group of the polyamine compound to form a plurality of amide-linked polyamines bound to at least a portion of the plurality of carbon nanotubes, and at least a second amine group of polyamine compound is further functionalized as a reaction product of an active acyl compound.

A third nonlimiting embodiment of the present disclosure incudes methods for processing an aqueous fluid, comprising: exposing an aqueous fluid comprising a hydrocarbon impurity, a salt impurity, or any combination thereof to a membrane material of the present disclosure; and separating the aqueous fluid into a permeate stream and a retentate stream; wherein the permeate stream has a lower concentration of at least one of the hydrocarbon impurity or the salt impurity relative to the aqueous fluid.

A third nonlimiting embodiment of the present disclosure includes methods, comprising: providing a plurality of carbon nanotubes comprising oxidized carbon nanotubes having a plurality of carboxylic acid groups; reacting at least a portion of the carboxylic acid groups with a first amine group of a polyamine compound to form first functionalized carbon nanotubes having a plurality of amide-linked polyamines bound to at least a portion of the plurality of carbon nanotubes; and reacting a second amine group of the polyamine compound with a diamine compound and an acid chloride compound having at least a first acid chloride group and a second acid chloride group to form second functionalized carbon nanotubes having a plurality of polyamide blocks attached to at least a portion of the amide-linked polyamines.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a graph depicting sodium chloride and magnesium sulfate rejection percentages for various membrane materials of the present disclosure.

FIG. 2 is a graph depicting heptane, toluene, and hexadecane rejection percentages for various membrane materials of the present disclosure.

### DETAILED DESCRIPTION

The present disclosure relates generally to membrane separations and, more particularly, membrane separations facilitated by carbon nanotubes.

The present disclosure provides membrane materials containing amine-functionalized carbon nanotubes, preferably polyamine-functionalized carbon nanotubes, in which the amine-functionalized carbon nanotubes are disposed (e.g., as at least one layer) upon a base substrate having a plurality of pores defined therein. The amine-functionalized carbon nanotubes may surprisingly improve selectivity of the membrane materials toward rejection of particular impurities from aqueous fluids and/or decrease the passage of various impurities through the base substrate. By improving impurity retention, water having an improved purity profile may be collected upon a permeate side of the membrane material. Carbon nanotubes may be readily functionalized with a polyamine and become disposed upon a base substrate containing a plurality of pores in order to accomplish the foregoing. Further functionalization of the polyamine may additionally occur upon the base substrate in accomplishing the foregoing. By virtue of their ready formation and relatively low cost, the membrane materials of the present disclosure may be incorporated into a filter, filtration system, or other similar device used for water treatment, including those capable of treating large quantities of water or other aqueous fluids.

The membrane materials of the present disclosure may provide more effective rejection of impurities (e.g., hydrocarbons, salts, the like, and combinations thereof) than do conventional approaches. Additionally, the embodiments of the present disclosure may facilitate a greater flux (throughput) of permeate water than do conventional systems as a consequence of increased rejection of impurities by the membrane materials. Membrane materials of the present disclosure may therefore reduce costs and improve overall efficiency of water treatment by potentially requiring fewer membranes, thinner membrane layers, and/or a lower membrane contact area for achieving effective separation, including water separations conducted upon a large scale.

Membrane materials of the present disclosure may comprise a base substrate having a plurality of pores defined therein, and a plurality of carbon nanotubes disposed upon the base substrate. The plurality of carbon nanotubes may be disposed upon a surface of the base substrate as at least one layer or thin film. In the disclosure herein, the plurality of carbon nanotubes comprises oxidized carbon nanotubes having a plurality of carboxylic acid groups, wherein at least a portion of the carboxylic acid groups have been reacted with a polyamine compound via a first amine group of the polyamine compound to form functionalized carbon nanotubes having a plurality of amide-linked polyamines bound to at least a portion of the plurality of carbon nanotubes. At least a second amine group of polyamine compound is further functionalized as a reaction product of an active acyl compound.

Carbon nanotubes (CNTs), including single walled-carbon nanotubes (SWCNTs) and multi-walled carbon nanotubes (MWCNTs), are an allotrope of carbon comprising cylindrical nanoscale carbon structures having rounded ends. The molecular structure of as-produced carbon nanotubes generally consists of rolled up sheets of sp2-hybridized carbon atoms. Carbon nanotubes have been studied in many fields. Among the modifications to surfaces that may be facilitated by carbon nanotubes include, for example, changes to reactivity, stability, and the like. Costs of carbon nanotubes have dropped considerably in recent years, thereby allowing for their incorporation in a diverse range of applications.

Oxidized carbon nanotubes may be opened on their ends and contain a plurality of carboxylic acid groups at this location. Hydroxyl groups may also be located at the position where carbon nanotubes have undergone oxidative opening. At least a majority of the carboxylic acid groups may be introduced to the carbon nanotubes upon performing an oxidation to open their ends. Suitable oxidizing agents for carbon nanotubes may include oxidizing acids such as, for example, nitric acid, sulfuric acid/hydrogen peroxide, or any combination thereof. Illustrative techniques for oxidizing carbon nanotubes using an oxidizing acid are described further in U.S. Pat. No. 7,008,604, which is incorporated herein by reference.

Oxidation of carbon nanotubes in an oxidizing acid may occur at an elevated temperature. Suitable elevated temperatures may include a temperature ranging from about 70° C. to about 150° C., or about 80° C. to about 120° C., or preferably about 100° C. to about 120° C. Oxidation of the carbon nanotubes may be performed for a time of about 1 hour to about 10 hours, or about 5 hours to about 7 hours, or even about 10 hours or more. In preparation for amine modification (functionalization), oxidized carbon nanotubes may be further purified by techniques such as, for example, centrifugation, filtration, solvent washing (e.g., with water or an organic solvent), the like, and any combination thereof.

The types of carbon nanotubes used for forming oxidized carbon nanotubes in the disclosure herein are not believed to be especially limited. The carbon nanotubes may comprise single-walled carbon nanotubes, double-walled carbon nanotubes, multi-walled carbon nanotubes, or any combination thereof. The carbon nanotubes may have a diameter of about 1 nm to about 200 nm, or about 20 nm to about 100 nm, or about 10 nm to about 80 nm, or about 4 nm to about 20 nm, or about 2 nm to about 12 nm. Any combination of carbon nanotubes within the foregoing size ranges may be used, including any combination of single-walled, double-walled, and multi-walled carbon nanotubes.

Prior to oxidation, the carbon nanotubes may have a length of about 20 μm to about 500 μm, or about 20 μm to about 200 μm, or about 20 μm to about 150 μm, or about 20 μm to about 100 μm, or about 50 μm to about 500 μm, or about 50 μm to about 200 μm, or about 50 μm to about 150 μm, or about 50 μm to about 100 μm, or about 100 μm to about 500 μm, or about 100 μm to about 200 μm, or about 100 μm to about 150 μm, or about 150 μm to about 500 μm, or about 150 μm to about 200 μm, or about 200 μm to about 500 μm. Depending on the extent of oxidation, the oxidized carbon nanotubes may differ in length from the original carbon nanotubes from which they are prepared.

As used in the present disclosure, the term “aspect ratio” refers to a ratio of width to length. Prior to oxidation, the carbon nanotubes may have an aspect ratio of about 100 to about 100,000, or about 100 to about 50,000, or about 500 to about 30,000, or about 1,000 to about 20,000, or about 1,000 to about 100,000, or about 1,000 to about 50,000, or about 1,000 to about 40,000, or about 1,000 to about 30,000, or about 1,000 to about 25,000, or about 1,000 to about 20,000, or about 1,000 to about 15,000, or about 1,000 to about 12,000, or about 1,000 to about 10,000, or about 1,000 to about 8,000.

Carbon nanotube diameters, lengths, and aspect ratios outside the foregoing ranges are additionally contemplated.

Oxidized carbon nanotubes may be treated with a reagent to convert at least a portion of the carboxylic acid groups resulting from oxidation into an acid halide. The acid halide may be reacted with a polyamine compound to form a plurality of amide-linked polyamines bound to at least a portion of the carbon nanotubes. Suitable reagents for forming an acid halide upon the oxidized carbon nanotubes include, but are not limited to thionyl chloride, oxalyl chloride, phosphorus oxychloride, phosphorus trichloride, phosphorus pentachloride, phosgene, and the like. Formation of the acid halides may take place with agitation, such as ultrasonication or stirring, and/or under heating conditions. Heating may take place at a temperature ranging from about 50° C. to about 100° C., or about 60° C. to about 90° C., or about 60° C. to about 80° C. over a time of, for example, about 1 hour to about 10 hours, or about 6 hours to about 10 hours.

Alternately, the amide-linked polyamines may be formed by activating the carboxylic acid groups with a peptide coupling agent, and reacting the activated carboxylic acid groups the polyamine compound. Suitable peptide coupling agents will be familiar to one having ordinary skill in the art.

At least a portion of the carboxylic acid groups within the oxidized carbon nanotubes may be reacted with a first amine group of the polyamine compound to form a plurality of amide-linked polyamines bound to at least a portion of the plurality of carbon nanotubes (i.e., via the carboxylic acid groups, optionally after conversion to an acid halide). Suitable polyamine compounds may include amine compounds containing 2, 3, or even more amine groups and preferably a plurality of amine groups. Preferably, the polyamine compound is an aliphatic polyamine compound. Suitable polyamine compounds may include, for example, ethylenediamine, 1,3-propylenediamine, 1,4-butanediamine, 1,5-pentanediamine, 1,6-hexanediamine, diethylenetriamine, triethylenetetraamine, tetraethylenepentaamine, and the like. More preferably, the polyamine is a polyethylenimine (also known as polyaziridine). Suitable polyethylenimines may be branched or linear polyethyleneimines.

Polyamine compounds, such as a polyethylenimine, may be combined with the oxidized carbon nanotubes or an acid chloride variant thereof at a suitable elevated temperature to promote formation of an amide bond via a first amine group of the polyamine compound, preferably with suitable agitation (e.g., stirring, sonication, the like, or any combination thereof). Suitable elevated temperatures for reacting the oxidized carbon nanotubes with the first amine group of the polyamine compound may range, for example, from about 50° C. to about 100° C., or about 60° C. to about 90° C., or about 60° C. to about 80° C., such as from about 12 hours to about 72 hours, or about 12 hours to about 36 hours, or about 18 hours to about 24 hours. The oxidized carbon nanotubes bound to the amide-linked polyamines may be further purified in any suitable manner.

Scheme 1 below shows the manner in which an amide-linked polyamine bound to an oxidized carbon nanotube may be produced, in which the polyamine compound is a linear polyethyleneimine (PEI). In Scheme 1, x is a positive integer. Other polyamines may be reacted similarly.

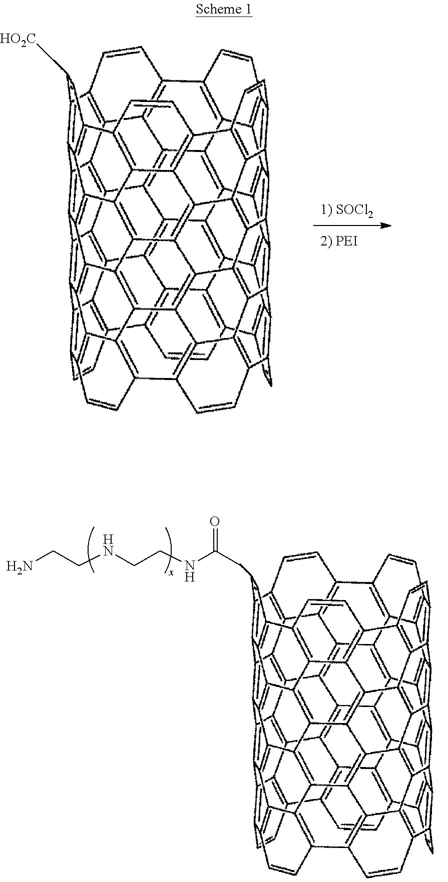

A second amine group of the polyamine compound may be further reacted with an active acyl compound, preferably an active acyl compound containing at least two active acyl groups. Suitable active acyl compounds may include acid halides (e.g., acid chlorides) and acid anhydrides. Accordingly, suitable acid chlorides may comprise at least two acid chloride groups, such as two acid chloride groups or three acid chloride groups. Suitable acid chloride compounds containing at least two acid chloride groups may include, but are not limited to, oxalyl chloride, malonyl chloride, succinyl chloride, adipoyl chloride, pimeloyl chloride, suberoyl chloride, azeloyl chloride, sebacoyl chloride, cyclohexanedicarbonyl chloride, phthaloyl chloride, isophthaloyl chloride, terephthaloyl chloride, 1,3,5-benzenetricarbonyl chloride, and the like. In the disclosure herein, the aromatic acid chlorides may be preferred due to their greater stability to water in comparison to aliphatic acid chlorides.

Acid chlorides and similar active acyl compounds containing at least two active acyl groups may be reacted with the amide-linked polyamine via a first active acyl group, leaving a second active acyl group available to undergo a further reaction. In the case of a dicarboxylic acid, a first acid chloride group of the acid chloride compound may be reacted with a second amine group of the polyamine compound (e.g., of the amide-linked polyamine compound bound to the oxidized carbon nanotubes), wherein the reaction takes place in the presence of a diamine compound. Reacting an acid chloride compound containing at least two acid chloride groups with the amide-linked polyamine in the presence of a diamine compound may promote attachment of a polyamide block to at least a portion of the amide-linked polyamines.

Scheme 2 below shows the manner in which a polyamide block may be attached to an amide-linked polyamine bound to an oxidized carbon nanotube, wherein the diamine is m-phenylenediamine and the acid chloride is isophthaloyl chloride. In Scheme 2, y is a positive integer. Other diamines and acid chlorides containing at least two acid chloride groups may be reacted similarly.

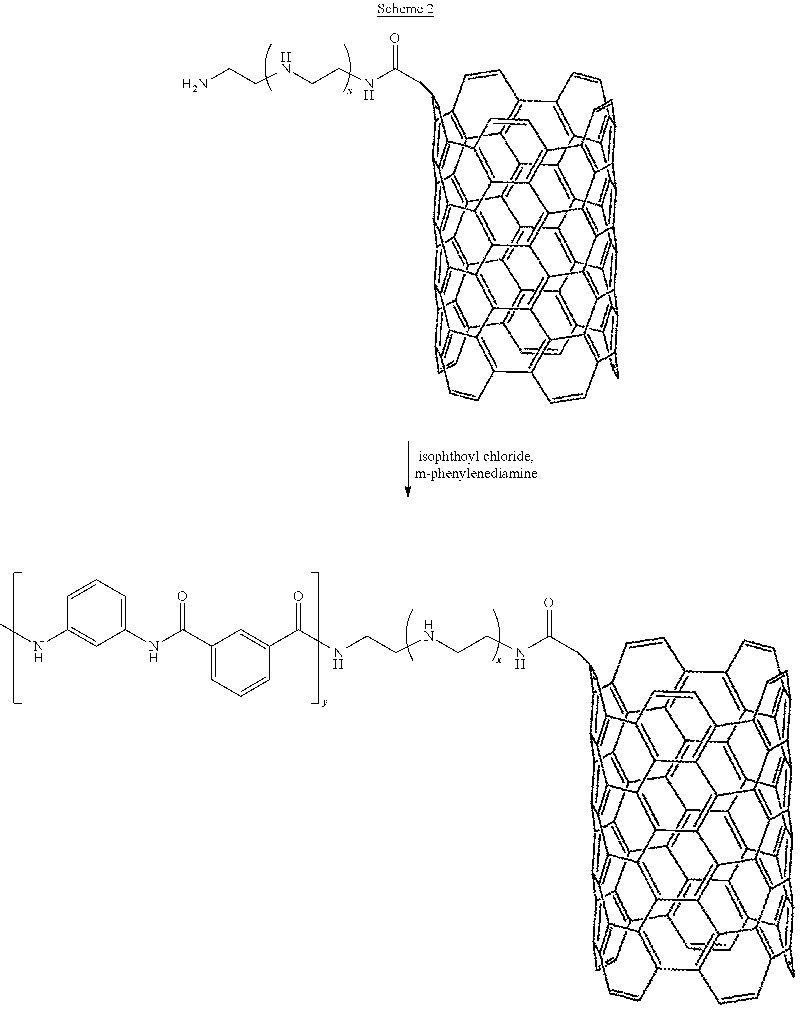

As an alternative, the active acyl compound may be formed in situ using a peptide coupling agent to promote a reaction. For example, instead of using isophthoyl chloride, isophthalic acid may be reacted with the amide-linked polyamine compound in the presence of a diamine compound to form a similar reaction product to that depicted in Scheme 2.

In another example, instead of reacting a diamine compound and an acid chloride compound containing at least two acid chloride groups, an amino acid may instead be coupled to the second amine group of the amide-linked polyamine to form a related polyamide block attached to at least a portion of the amide-linked polyamines. A peptide coupling agent may be used in this regard. The foregoing approach is shown in Scheme 3 below.

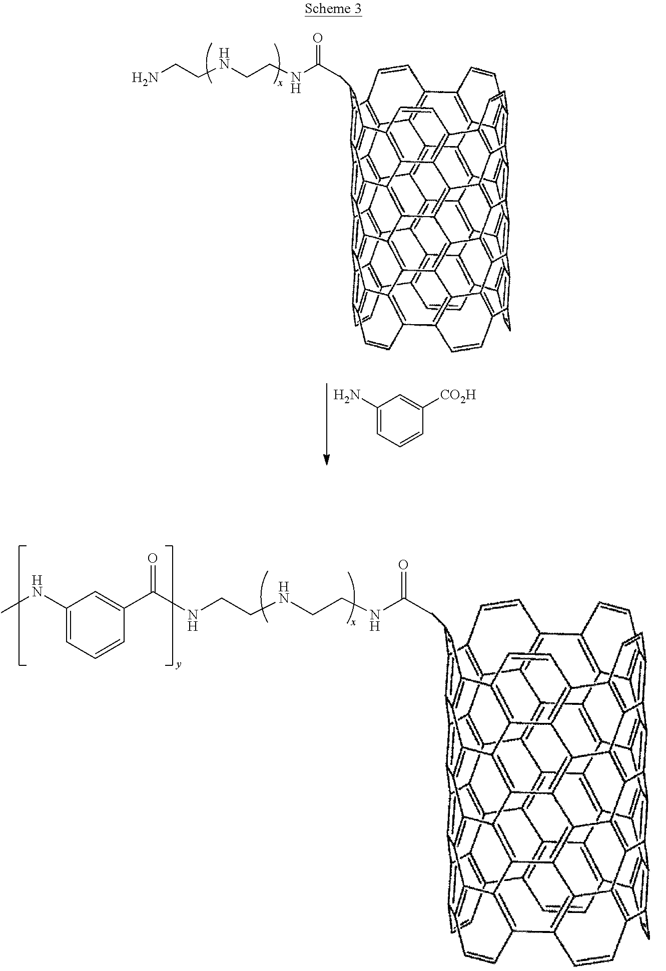

Optionally, the acid chloride may comprise a third acid chloride group (or a third carboxylic acid group if activation occurs in situ). When present, a third acid chloride group may facilitate crosslinking between a first polyamide block and a second polyamide block in combination with the diamine compound. Formula 1 below shows an illustrative product containing a crosslink between a first polyamide block and a second polyamide block when the acid chloride is 1,3,5-benzenetricarbonyl chloride.

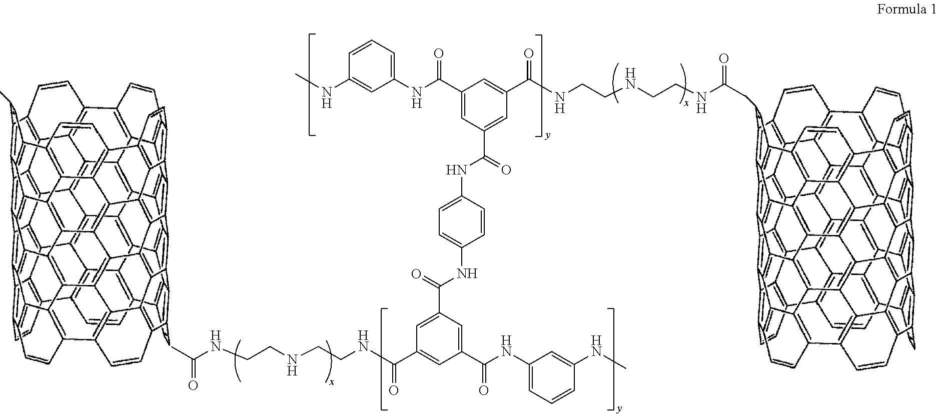

In a related reaction, an acid chloride compound containing at least two acid chloride groups may form crosslinks between side-chain amine groups in branched polyethyleneimines that are amide-linked to the carbon nanotubes, or between a side-chain amine group in branched polyethyleneimines and a polyamide block.

The active acyl compound may be contacted with the carbon nanotubes and reacted with the second amine group of the amide-linked polyamine in an aqueous solution or dispersion, wherein the aqueous solution or dispersion may have a concentration of 0.1 w/v % to 5 w/v %, or 0.1 w/v % to 3 w/v %, or 0.5 w/v % to 2.5 w/v %, or 1 w/v % to 2 w/v %, or about 1 w/v %, or about 2 w/v %, based on a mass of the active acyl compound per total volume of the aqueous solution or dispersion.

The oxidized carbon nanotubes having the polyamide block bound thereto via the amide-linked polyamine may be further disposed upon a base substrate having a plurality of pores defined therein, thereby defining a membrane material. The base substrate may comprise any suitable material that is itself semi-permeable. The term “semi-permeable,” as used herein, refers to a material that may permit transfer of a desired species (e.g., water) across the material but not permit free transfer of other species (e.g., impurities such as salts, hydrocarbons, the like, or any combination thereof). Examples of suitable base substrates suitable for forming a membrane material of the present disclosure may include polymers such as, but not limited to, polysulfone, polyethersulfone, polycarbonate, polytetrafluoroethylene, polyvinylidene fluoride (e.g., hydrophilic PVDF), polyester, fluorinated polyimides, polyethyloxazolines, a fluoropolymer-copolymer (e.g., NAFION®), polyamide, polyethylene terephthalate (PET), the like, or any combination thereof. Optionally, a surface of the base substrate may be activated by exposure to acid prior to disposing the carbon nanotubes thereon. Activation may involve removal of surface impurities, functional group transformation, or any combination thereof.

An aqueous solution or dispersion may be utilized to introduce the carbon nanotubes functionalized with the amide-linked polyamine to the surface of the base substrate. The aqueous solution or dispersion may have a carbon nanotube concentration of about 0.1 wt % to about 2 wt %, or about 0.1 wt % to about 1.1 wt %, or about 0.25 wt % to about 1 wt %, or about 0.25 wt % to about 0.5 wt % or to about 1 wt %, each based on a total mass of functionalized carbon nanotubes per total mass of the aqueous solution or dispersion. Introduction of the carbon nanotubes to the base substrate may occur, for example, by dip coating or immersion of the base substrate in the aqueous solution or dispersion. Printing, painting, or similar techniques may also be used to introduce the carbon nanotubes to the base substrate. Immersion may occur for any suitable time including from about 1 minute to about 120 minutes, or about 1 minute to about 60 minutes, or about 1 minute to about 20 minutes, or about 1 minute to about 10 minutes, or about 5 minutes to about 15 minutes or to about 10 minutes.

A film coating machine may be used in conjunction with forming the membrane materials of the present disclosure. One having ordinary skill in the art will be able to select and use such machines within the context of the present disclosure. Suitable film coating machines may include, but are not limited to, a doctor blade coating machine, or the like.

The carbon nanotubes within the aqueous solution or dispersion may comprise oxidized carbon nanotubes containing an amide-linked polyamine that has not yet been reacted with an active acyl compound, in which case formation of a polyamide block bound to the amide-linked polyamine via a second amine group of the polyamine may take place upon the surface of the base substrate. When the polyamide block is formed upon the surface of the base substrate, the aqueous solution may further contain the diamine compound for deposition upon the surface of the base substrate. Once deposited upon the base substrate, the diamine compound and the amide-linked polyamines may be exposed to the active acyl compound (e.g., an acid chloride containing at least two acid chloride groups) to form the polyamide block bound to the amide-linked polyamine. Crosslinking between a first polyamide block and a second polyamide block, between side-chain amines of branched polyethyleneimines, or between a polyamide block and a side-chain of branched polyethyleneimines may similar take place upon a surface upon contacting a suitable active acyl compound.

In another example, covalent bonding of the carbon nanotubes or the polyamide block may take place to the surface of the base substrate. For example, if the base substrate contains reactive functional groups, such as surface amine groups or hydroxyl groups, these reactive functional groups may react with the active acyl compound to promote covalent bond formation via the polyamide block. Hydroxyl groups upon the oxidized carbon nanotubes may similarly react to form covalent bonds to the surface of the base substrate in the presence of the active acyl compound as well.

After depositing the carbon nanotubes upon the base substrate, the membrane material may be heated (e.g., in an oven) to harden the polymer within or upon the base substrate. Crosslinking may be completed during this time, for example. Suitable temperatures and heating times may include about 1 minute to about 30 minutes, or about 1 minute to about 10 minutes, or about 1 minute to about 6 minutes, or about 1 minute to about 5 minutes, and a temperature of about 40° C. to about 100° C., or about 40° C. to about 80° C., or about 40° C. to about 70° C.

The membrane materials of the present disclosure are not believed to be particularly limited in area or thickness. In non-limiting examples, membrane materials may range in thickness from about 1 μm to about 1000 μm. Even higher total thicknesses up to even about 5000 μm are contemplated herein. The thickness of the membrane materials includes the thickness supplied by a thin film layer of oxidized carbon nanotubes functionalized as described herein. In non-limiting examples, the thin film may have a thickness ranging from about 10 nm to about 100 nm, or about 50 nm to about 500 nm, or about 20 nm to about 250 nm, or about 20 nm to about 50 nm, or about 30 nm to about 80 nm, or about 60 nm to about 100 nm. In addition to localizing upon the surface of the base substrate, the carbon nanotubes may at least partially penetrate below the surface of the base substrate in some cases. The remaining thickness of the membrane materials may be defined by the as-supplied thickness of the base substrate.

The membrane materials may be incorporated in filters and filtration systems suitable for removing at least one contaminant from water or other aqueous fluids. Suitable filtration systems may comprise the membrane material, an inlet to supply water or an aqueous fluid to the membrane material, and an outlet to remove a retentate stream that has passed through the membrane material. Accordingly, the present disclosure further provides methods for treating aqueous fluids, such as water, comprising: exposing an aqueous fluid comprising a hydrocarbon impurity, a salt impurity, or any combination thereof to a membrane material of the present disclosure, and separating the aqueous fluid into a permeate stream and a retentate stream. The permeate stream has a lower concentration of at least one of the hydrocarbon impurity or the salt impurity relative to the aqueous fluid.

It should be appreciated that one having ordinary skill in the art will, with the benefit of the present disclosure, be able to implement the methods and systems described above. It should further be noted that additional nonlimiting steps, chemicals, functional groups, and/or system components may be used in formation and utilization of the membrane materials described herein but are not included for the sake of brevity. Such additional components will be familiar to one having ordinary skill in the art.

### Additional Embodiments

Embodiments disclosed herein include:

A. Membrane materials. The membrane materials comprise: a base substrate having a plurality of pores defined therein; and a plurality of carbon nanotubes disposed upon the base substrate; wherein the plurality of carbon nanotubes comprises oxidized carbon nanotubes having a plurality of carboxylic acid groups; wherein at least a portion of the carboxylic acid groups have been reacted with a polyamine compound via a first amine group of the polyamine compound to form a plurality of amide-linked polyamines bound to at least a portion of the plurality of carbon nanotubes, and at least a second amine group of polyamine compound is further functionalized as a reaction product of an active acyl compound.

A1. Filtration systems including the membrane material of A.

B. Methods for removing impurities from an aqueous fluid. The methods comprise: exposing an aqueous fluid comprising a hydrocarbon impurity, a salt impurity, or any combination thereof to the membrane material of A; and separating the aqueous fluid into a permeate stream and a retentate stream; wherein the permeate stream has a lower concentration of at least one of the hydrocarbon impurity or the salt impurity relative to the aqueous fluid.

C. Methods for functionalizing carbon nanotubes. The methods comprise: providing a plurality of carbon nanotubes comprising oxidized carbon nanotubes having a plurality of carboxylic acid groups; reacting at least a portion of the carboxylic acid groups with a first amine group of a polyamine compound to form first functionalized carbon nanotubes having a plurality of amide-linked polyamines bound to at least a portion of the plurality of carbon nanotubes; and reacting a second amine group of the polyamine compound with a diamine compound and an acid chloride compound having at least a first acid chloride group and a second acid chloride group to form second functionalized carbon nanotubes having a plurality of polyamide blocks attached to at least a portion of the amide-linked polyamines.

Each of embodiments A through C may have one or more of the following additional elements in any combination:

Element 1: wherein the base substrate comprises a polyethersulfone.

Element 2: wherein the polyamine compound comprises a polyethylenimine.

Element 3: wherein the polyethylenimine comprises a linear polyethylenimine.

Element 4: wherein the active acyl compound comprises an acid chloride compound.

Element 5: wherein the acid chloride compound comprises at least two acid chloride groups.

Element 6: wherein a first acid chloride group of the acid chloride compound is reacted with the second amine group of the polyamine compound in the presence of a diamine compound to form the reaction product of the active acyl compound as a polyamide block attached to at least a portion of the amide-linked polyamines.

Element 7: wherein the diamine compound comprises a phenylenediamine.

Element 8: wherein the acid chloride compound comprises a third acid chloride group, and the third acid chloride group and the diamine compound form a crosslink between a first polyamide block and a second polyamide block.

Element 9: wherein the acid chloride compound comprises 1,3,5-benzenetricarbonyl chloride.

Element 10: wherein the membrane material comprises 0.1 wt % to 1.1 wt % carbon nanotubes, based on a total mass of the membrane material.

Element 11: wherein the method further comprises disposing the second functionalized carbon nanotubes upon a base substrate having a plurality of pores defined therein.

Element 12: wherein the second functionalized carbon nanotubes are formed upon a surface of the base substrate.

By way of non-limiting example, exemplary combinations applicable to A, A1, B, and C include, but are not limited to: 1 and 2; 1-3; 1 and 4; 1, 4, and 5; 1 and 4-6; 1 and 4-7; 1 and 4-8; 1 and 10; 1, 2, and 10; 2 and 3; 2 and 4; 2, 4, and 5; 2 and 4-6; 2 and 4-7; 2 and 4-8; 2 and 10; 4 and 5; 4-6; 4-7; 4-8; and 4 and 10.

Additional exemplary combinations applicable to C include, but are not limited to: any one of 1-10 in further combination with 11; any one of 1-10 in further combination with 12; any of the foregoing exemplary combinations in further combination with 11; any of the foregoing exemplary combinations in further combination with 12; and 11 and 12.

Additional embodiments disclosed herein include:

Clause 1: A membrane material comprising: a base substrate having a plurality of pores defined therein; and a plurality of carbon nanotubes disposed upon the base substrate; wherein the plurality of carbon nanotubes comprises oxidized carbon nanotubes having a plurality of carboxylic acid groups; wherein at least a portion of the carboxylic acid groups have been reacted with a polyamine compound via a first amine group of the polyamine compound to form a plurality of amide-linked polyamines bound to at least a portion of the plurality of carbon nanotubes, and at least a second amine group of polyamine compound is further functionalized as a reaction product of an active acyl compound.

Clause 2: The membrane material of clause 1, wherein the base substrate comprises a polyethersulfone.

Clause 3: The membrane material of clause 1 or 2, wherein the polyamine compound comprises a polyethylenimine.

Clause 4: The membrane material of clause 3, wherein the polyethylenimine comprises a linear polyethylenimine.

Clause 5: The membrane material of any one of clauses 1-4, wherein the active acyl compound comprises an acid chloride compound.

Clause 6: The membrane material of clause 5, wherein the acid chloride compound comprises at least two acid chloride groups.

Clause 7: The membrane material of clause 6, wherein a first acid chloride group of the acid chloride compound is reacted with the second amine group of the polyamine compound in the presence of a diamine compound to form the reaction product of the active acyl compound as a polyamide block attached to at least a portion of the amide-linked polyamines.

Clause 8: The membrane material of clause 7, wherein the diamine compound comprises a phenylenediamine.

Clause 9: The membrane material of clause 7 or clause 8, wherein the acid chloride compound comprises a third acid chloride group, and the third acid chloride group and the diamine compound form a crosslink between a first polyamide block and a second polyamide block.

Clause 10: The membrane material of any one of clauses 7-9, wherein the acid chloride compound comprises 1,3,5-benzenetricarbonyl chloride.

Clause 11: The membrane material of any one of clauses 1-10, wherein the membrane material comprises 0.1 wt % to 1.1 wt % carbon nanotubes, based on a total mass of the membrane material.

Clause 12: A filtration system comprising the membrane material of any one of clauses 1-11.

Clause 13: A method comprising: exposing an aqueous fluid comprising a hydrocarbon impurity, a salt impurity, or any combination thereof to the membrane material of claim 1; and separating the aqueous fluid into a permeate stream and a retentate stream; wherein the permeate stream has a lower concentration of at least one of the hydrocarbon impurity or the salt impurity relative to the aqueous fluid.

Clause 14: A method comprising: providing a plurality of carbon nanotubes comprising oxidized carbon nanotubes having a plurality of carboxylic acid groups; reacting at least a portion of the carboxylic acid groups with a first amine group of a polyamine compound to form first functionalized carbon nanotubes having a plurality of amide-linked polyamines bound to at least a portion of the plurality of carbon nanotubes; and reacting a second amine group of the polyamine compound with a diamine compound and an acid chloride compound having at least a first acid chloride group and a second acid chloride group to form second functionalized carbon nanotubes having a plurality of polyamide blocks attached to at least a portion of the amide-linked polyamines.

Clause 15: The method of clause 14, further comprising: disposing the second functionalized carbon nanotubes upon a base substrate having a plurality of pores defined therein.

Clause 16: The method of clause 15, wherein the base substrate comprises a polyethersulfone.

Clause 17: The method of clause 15 or clause 16, wherein the second functionalized carbon nanotubes are formed upon a surface of the base substrate.

Clause 18: The method of any one of clauses 14-17, wherein the polyamine compound comprises a polyethylenimine.

Clause 19: The method of clause 18, wherein the polyethylenimine comprises a linear polyethylenimine.

Clause 20: The method of any one of clauses 14-19, wherein the diamine compound comprises a phenylenediamine.

Clause 21: The method of any one of clauses 14-20, wherein the acid chloride compound comprises a third acid chloride group, and the third acid chloride group and the diamine compound react to form a crosslink between a first polyamide block and a second polyamide block.

### Examples

### Membrane Preparation

Oxidized carbon nanotubes were produced by dispersing as-received carbon nanotubes in water, adding nitric acid, and refluxing at 110° C. for 6 hours. The oxidized carbon nanotubes were separated by centrifugation and washed with deionized water.

The oxidized carbon nanotubes were then reacted with thionyl chloride in anhydrous dimethylformamide under ultrasonication for 60 minutes, followed by an additional 8 hours of heating at 70° C. Thereafter, the resulting acid chloride-functionalized carbon nanotubes were collected by centrifugation, and polyethyleneimine (PEI) was added thereto. After stirring at 70° C. for 24 hours, the resulting PEI-functionalized carbon nanotubes were collected.

To prepare membrane materials having the carbon nanotubes incorporated thereon, a polyethersulfone membrane was activated by immersion in a dilute nitric acid solution for one day. Activation was performed to promote adherence of a thin carbon nanotube film thereto. After activation, the polyethersulfone membrane was immersed for 10 minutes in a dilute aqueous solution containing various amounts of PEI-functionalized carbon nanotubes (0 wt %, 0.25 wt %, 0.5 wt %, and 1 wt %) and also containing m-phenylenediamine. After loading the PEI-functionalized carbon nanotubes on the membrane, a 2% w/v solution of benzenetricarbonyl chloride in n-hexane was applied via doctor blading over 4 minutes to promote polyamide grafting. Thereafter, the membranes were placed in a 60° C. oven for 5 minutes to harden the polymer.

### Permeability Testing Procedure

Membrane permeability was tested using an apparatus (Sterlitech Company) filter cell having a 36 cm² membrane housed therein. The membranes were prepared as above. The following fluids were prepared: deionized water (control fluid) and a test fluid containing 1000 ppm NaCl, 1000 ppm MgSO₄·100 ppm n-heptane, 100 ppm toluene, and 100 ppm hexadecane in deionized water. Testing was conducted by first exposing the membrane to the control fluid for 3 hours, followed by 3 hours of exposure to the test fluid. The test fluid was stirred continuously to minimize polarization effects. Testing was conducted at 200 psi and room temperature. Permeate samples were collected at 4 minute intervals for further analysis.

Permeability was calculated according to Equation 1 below:

$$J = \frac{V}{A t} \qquad Equation l$$

where J is the permeate flux (L m⁻²h⁻¹), V is the volume of the collected permeate water at a certain time (L), A is the effective area (m²) of the membrane, and t is the time elapsed (h) in collecting the sample. Rejection percentage was calculated according to Equation 2 below:

$$R ( \% ) = ( 1 - \frac{{C}_{p e r}}{{C}_{feed}} ) \times 100 \qquad Equation 2$$

where R is the rejection percentage (%) of a given component of the combined fluid, Cₚₑᵣ is the concentration of the concentration of the component in the permeate water, and C_{feed} is the concentration of the component in the combined fluid. Measurements were conducted in duplicate for each membrane type and averaged to obtain final values.

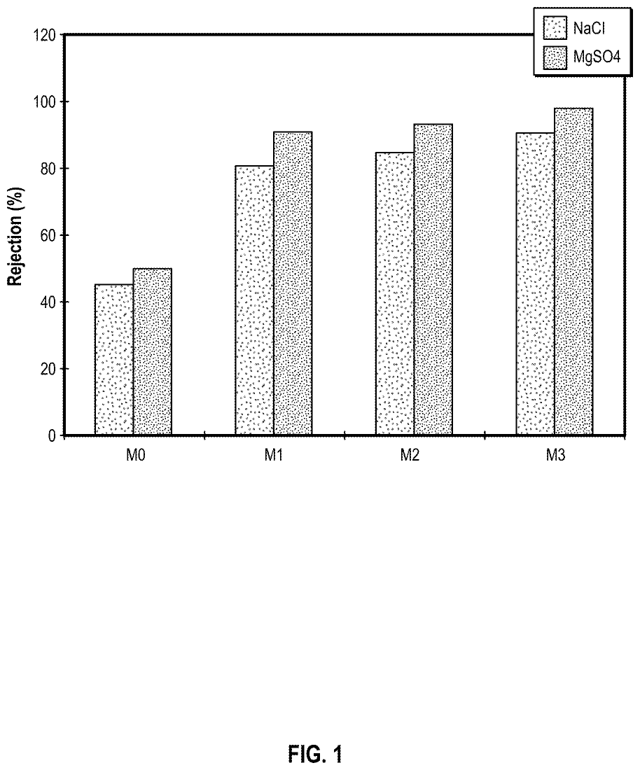

FIG. 1 is a graph depicting sodium chloride and magnesium sulfate rejection percentages for various membranes. As shown in FIG. 1, M0 (bare membrane with no added carbon nanotubes) afforded rejection values around only 50% for NaCl and 45% for MgSO₄. The rejection values were significantly enhanced for both salts by modifying the membrane with carbon nanotubes (experimental membranes M1-M3). For example, rejection values increased to about 81% for NaCl and 92% for MgSO₄ in M1 at a loading of 0.25 wt % carbon nanotubes. Even further increases were realized in M2 and M3 (0.5 wt % and 1 wt % carbon nanotubes, respectively). M3 achieved rejection values of about 91% for NaCl and 98% for MgSO₄.

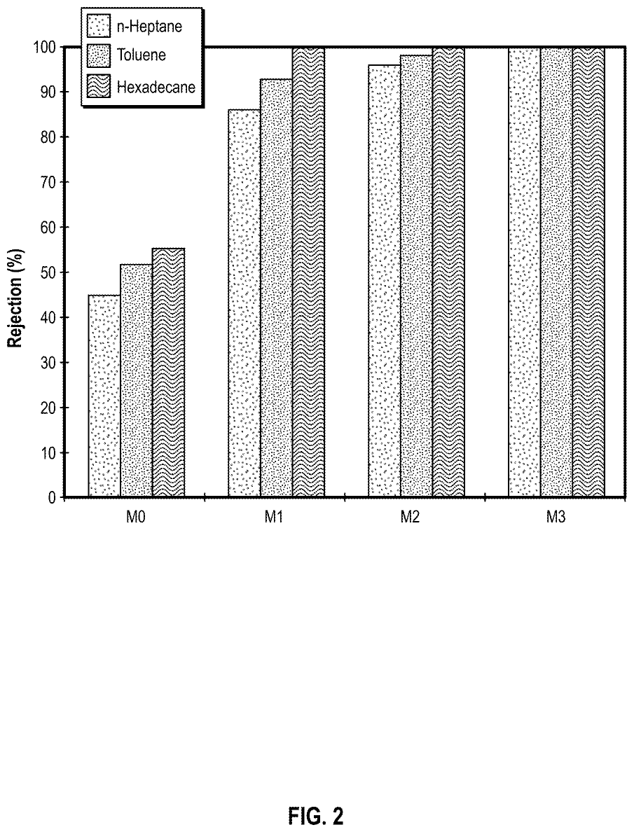

FIG. 2 is a graph depicting heptane, toluene, and hexadecane rejection percentages for various membranes. As shown, hydrocarbon rejection values were similarly significantly enhanced by introducing carbon nanotubes onto the surface of the membrane, and the rejection percentage increased with increased carbon nanotube loading. For both M2 and M3, the rejection percentages were about 95% or greater for all of the hydrocarbons tested.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A membrane material comprising:
a base substrate having a plurality of pores defined therein; and
a plurality of carbon nanotubes disposed upon the base substrate;
wherein the plurality of carbon nanotubes comprises oxidized carbon nanotubes having a plurality of carboxylic acid groups;
wherein at least a portion of the carboxylic acid groups have been reacted with a polyamine compound via a first amine group of the polyamine compound to form a plurality of amide-linked polyamines bound to at least a portion of the plurality of carbon nanotubes, and at least a second amine group of polyamine compound is further functionalized as a reaction product of an active acyl compound.

2. The membrane material of claim 1, wherein the base substrate comprises a polyethersulfone.

3. The membrane material of claim 1, wherein the polyamine compound comprises a polyethylenimine.

4. The membrane material of claim 3, wherein the polyethylenimine comprises a linear polyethylenimine.

5. The membrane material of claim 1, wherein the active acyl compound comprises an acid chloride compound.

6. The membrane material of claim 5, wherein the acid chloride compound comprises at least two acid chloride groups.

7. The membrane material of claim 6, wherein a first acid chloride group of the acid chloride compound is reacted with the second amine group of the polyamine compound in the presence of a diamine compound to form the reaction product of the active acyl compound as a polyamide block attached to at least a portion of the amide-linked polyamines.

8. The membrane material of claim 7, wherein the diamine compound comprises a phenylenediamine.

9. The membrane material of claim 7, wherein the acid chloride compound comprises a third acid chloride group, and the third acid chloride group and the diamine compound form a crosslink between a first polyamide block and a second polyamide block.

10. The membrane material of claim 7, wherein the acid chloride compound comprises 1,3,5-benzenetricarbonyl chloride.

11. The membrane material of claim 1, wherein the membrane material comprises 0.1 wt % to 1.1 wt % carbon nanotubes, based on a total mass of the membrane material.

12. A filtration system comprising the membrane material of claim 1.

13. A method comprising:
exposing an aqueous fluid comprising a hydrocarbon impurity, a salt impurity, or any combination thereof to the membrane material of claim 1; and
separating the aqueous fluid into a permeate stream and a retentate stream;
wherein the permeate stream has a lower concentration of at least one of the hydrocarbon impurity or the salt impurity relative to the aqueous fluid.

14. A method comprising:
providing a plurality of carbon nanotubes comprising oxidized carbon nanotubes having a plurality of carboxylic acid groups;
reacting at least a portion of the carboxylic acid groups with a first amine group of a polyamine compound to form first functionalized carbon nanotubes having a plurality of amide-linked polyamines bound to at least a portion of the plurality of carbon nanotubes; and
reacting a second amine group of the polyamine compound with a diamine compound and an acid chloride compound having at least a first acid chloride group and a second acid chloride group to form second functionalized carbon nanotubes having a plurality of polyamide blocks attached to at least a portion of the amide-linked polyamines.

15. The method of claim 14, further comprising:
disposing the second functionalized carbon nanotubes upon a base substrate having a plurality of pores defined therein.

16. The method of claim 15, wherein the base substrate comprises a polyethersulfone.

17. The method of claim 15, wherein the second functionalized carbon nanotubes are formed upon a surface of the base substrate.

18. The method of claim 14, wherein the polyamine compound comprises a polyethylenimine.

19. The method of claim 14, wherein the diamine compound comprises a phenylenediamine.

20. The method of claim 14, wherein the acid chloride compound comprises a third acid chloride group, and the third acid chloride group and the diamine compound react to form a crosslink between a first polyamide block and a second polyamide block.
